(19) United States
(12) Patent Application Publication
(10) Pub. No.: US 2016/0288572 A1
(43) Pub. Date: Oct. 6, 2016

(54) BIDIRECTIONAL MONOBELT CONSTRUCTION FOR A PNEUMATIC TIRE

(71) Applicant: The Goodyear Tire & Rubber Company, Akron, OH (US)

(72) Inventors: Phaniraj Muthigi, Copley, OH (US); David Ray Hubbell, Hartville, OH (US); James Gregory Gillick, Akron, OH (US); Joseph Henry Laco, Akron, OH (US); Rebecca Lee Dando, Uniontown, OH (US); Vaidyanathan Sankar, Schieren (LU); Thierry Royer, Arlon (BE); Gilles Bonnet, Niederfeulen (LU)

(21) Appl. No.: 14/674,248

(22) Filed: Mar. 31, 2015

(51) Int. Cl. B60C 9/04

(52) U.S. Cl. CPC B60C 9/04

(57) ABSTRACT

A pneumatic tire includes a carcass reinforced by a carcass ply extending from a first bead to a second bead and a single belt ply disposed radially outward of the carcass ply in a crown portion of the pneumatic tire. The single belt ply includes a first group of cords oriented in a first direction relative to a centerline of the pneumatic tire and a second group of cords oriented in a second direction relative to the centerline of the pneumatic tire.

### FIELD OF THE INVENTION

The present invention relates to a pneumatic tire, and more particularly, to a belt construction for a pneumatic tire.

### BACKGROUND OF THE INVENTION

A pneumatic tire typically includes a pair of axially separated inextensible beads. A circumferentially disposed bead filler apex extends radially outward from each respective bead. At least one carcass ply extends between the two beads. The carcass ply has axially opposite end portions, each of which is turned up around a respective bead and secured thereto. Tread rubber and sidewall rubber is located axially and radially outward, respectively, of the carcass ply. A belt structure is disposed radially between the carcass ply and tread rubber.

The bead area is one part of the tire that contributes a substantial amount to the rolling resistance of the tire, due to cyclical flexure which also leads to heat buildup. Under conditions of severe operation, as with runflat and high performance tires, the flexure and heating in the bead region can be especially problematic, leading to separation of mutually adjacent components that have disparate properties, such as the respective moduli of elasticity. In particular, the ply turnup ends may be prone to separation from adjacent structural elements of the tire.

A conventional ply may be reinforced with materials such as polyamide/nylon, polyester, rayon, and/or metal, which have much greater stiffness (i.e., modulus of elasticity) than the adjacent rubber compounds of which the bulk of the tire is made. The difference in elastic modulus of mutually adjacent tire elements may lead to separation when the tire is stressed and deformed during use.

A conventional belt structure comprises a plurality of reinforcement layers in which cords are laid parallel to each other. Due to the unidirectional load carrying capability of each reinforcement layer, an even number of such layers may be stacked up to manage the force transfer in opposite directions. Two such reinforcement layers of steel wires may be used as a belt-package in a typical radial passenger tire, contributing significant weight to the pneumatic tire.

### SUMMARY OF THE PRESENT INVENTION

A pneumatic tire in accordance with the present invention includes a carcass reinforced by a carcass ply extending from a first bead to a second bead and a single belt ply disposed radially outward of the carcass ply in a crown portion of the pneumatic tire. The single belt ply includes a first group of cords oriented in a first direction relative to a centerline of the pneumatic tire and a second group of cords oriented in a second direction relative to the centerline of the pneumatic tire. The first direction may be, for example, equal and opposite to the second direction.

According to another aspect of the pneumatic tire, the first group of cords has a linear density value in the range between 1000 dtex to 4000 dtex.

According to still another aspect of the pneumatic tire, the first group of cords has a structure of one single polyamide/nylon core yarn and two, and only two, aramid wrap yarns.

According to yet another aspect of the pneumatic tire, the first group of cords has an end count of cord ends per inch in the range between 15-32.

According to still another aspect of the pneumatic tire, the second group of cords has a linear density value in the range between 1000 dtex to 2000 dtex.

According to yet another aspect of the pneumatic tire, the second group of cords has a linear density value in the range between 3000 dtex to 4000 dtex.

According to still another aspect of the pneumatic tire, the second group of cords has a structure of one single polyamide/nylon core yarn and two, and only two, aramid wrap yarns.

According to yet another aspect of the pneumatic tire, the second group of cords has an end count of cord ends per inch in the range between 15-32.

A method in accordance with the present invention designs a pneumatic tire. The method includes the step of replacing a first belt and a second belt with a single third belt, the third belt comprising a first group of cords oriented in a first direction relative to a centerline of the pneumatic tire and a second group of cords oriented in a second direction relative to the centerline of the pneumatic tire, the first direction, for example, being equal and opposite to the second direction.

### Definitions

“Apex” or “bead filler apex” means an elastomeric filler located radially above the bead core and between the plies and the turnup plies.

“Axial” and “Axially” mean the lines or directions that are parallel to the axis of rotation of the tire.

“Bead” or “Bead Core” generally means that part of the tire comprising an annular tensile member of radially inner beads that are associated with holding the tire to the rim; the beads being wrapped by ply cords and shaped, with or without other reinforcement elements such as flippers, chippers, apexes or fillers, toe guards and chafers.

“Carcass” means the tire structure apart from the belt structure, tread, undertread over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” most often means circular lines or directions extending along the perimeter of the surface of the annular tread perpendicular to the axial direction; it can also refer to the direction of the sets of adjacent circular curves whose radii define the axial curvature of the tread, as viewed in cross section.

“Cord” means one of the reinforcement strands, including fibers, with which the plies and belts are reinforced.

“Equatorial Plane” means the plane perpendicular to the tire's axis of rotation and passing through the center of its tread; or the plane containing the circumferential centerline of the tread.

“Flipper” refers to a reinforcing fabric around the bead wire for strength and to tie the bead wire in the tire body.

“Gauge” refers generally to a measurement and specifically to thickness.

“Inner Liner” means the layer or layers of elastomer or other material that form the inside surface of a tubeless tire and that contain the inflating fluid within the tire.

“Lateral” means a direction parallel to the axial direction.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Toe guard” refers to the circumferentially deployed elastomeric rim-contacting portion of the tire axially inward of each bead.

“Tread width” means the arc length of the tread surface in the plane includes the axis of rotation of the tire.

“Turnup end” means the portion of a carcass ply that turns upward (i.e., radially outward) from the beads about which the ply is wrapped.

### BRIEF DESCRIPTION OF THE DRAWINGS

The structure, operation, and advantages of the invention will become more apparent upon contemplation of the following description taken in conjunction with the accompanying drawings, wherein:

FIG. 1 represents a schematic cross-sectional view of an example tire for use with the present invention;

FIG. 2 represents a schematic detail view of the bead region of the example tire shown in FIG. 1; and

FIG. 3 represents a schematic detail view of a single belt ply in accordance with the present invention.

### DETAILED DESCRIPTION OF EXAMPLE EMBODIMENTS OF THE PRESENT INVENTION

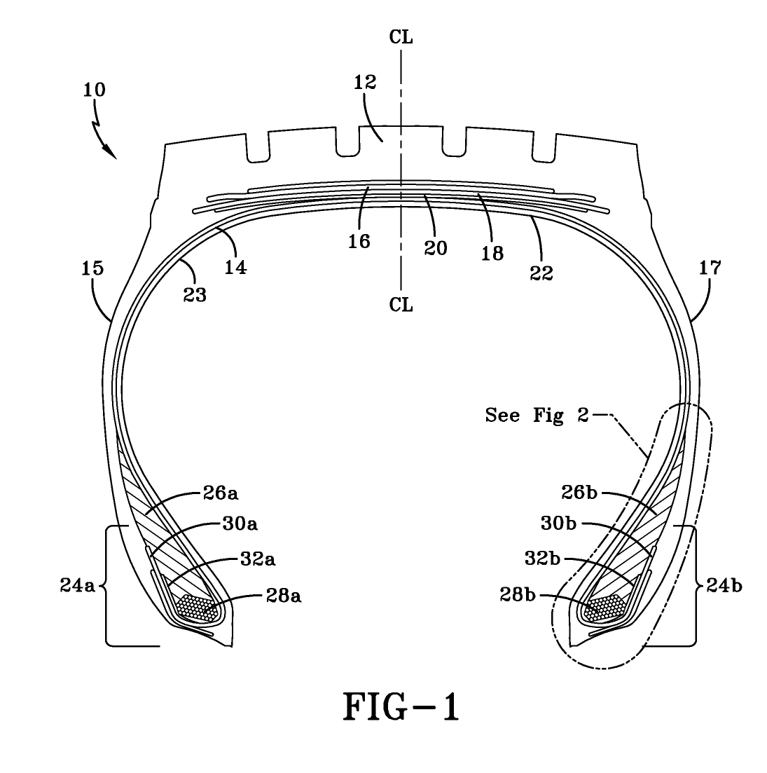

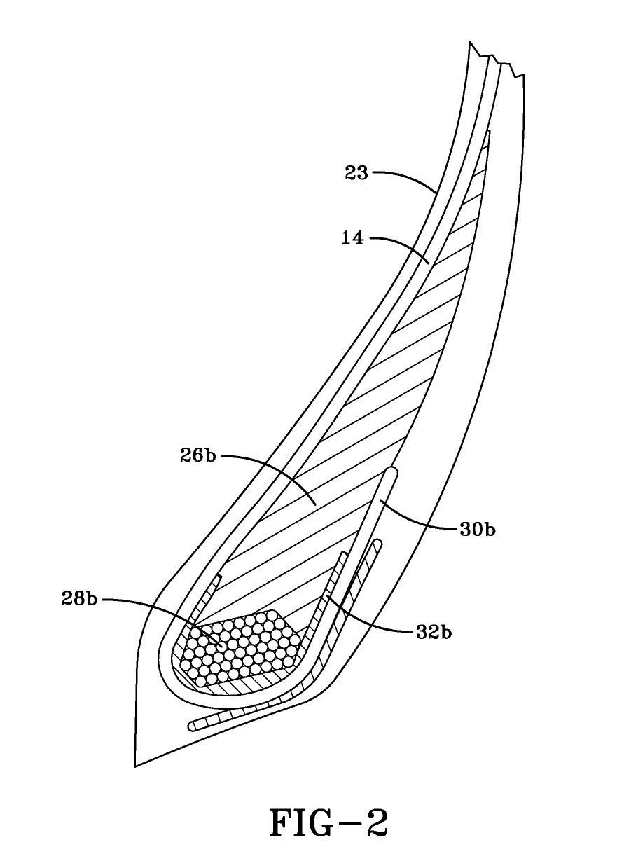

FIGS. 1 and 2 show an example tire 10 for use with reinforcing structures, such as flippers and chippers, in accordance with the present invention. The example tire 10 has a tread 12, an inner liner 23, an overlay 16, a belt structure comprising belts 18, 20, a carcass 22 with a single carcass ply 14, two sidewalls 15,17, and two bead regions 24a, 24b comprising bead filler apexes 26a, 26b and beads 28a, 28b. The example tire 10 is suitable, for example, for mounting on a rim of a passenger vehicle. The carcass ply 14 includes a pair of axially opposite end portions 30a, 30b, each of which is secured to a respective one of the beads 28a, 28b. Each axial end portion 30a or 30b of the carcass ply 14 is turned up and around the respective bead 28a, 28b to a position sufficient to anchor each axial end portion 30a, 30b, as seen in detail in FIG. 2.

The carcass ply 14 may be a rubberized ply having a plurality of substantially parallel carcass reinforcing members made of such material as polyester, rayon, or similar suitable organic polymeric compounds. The carcass ply 14 may engage the axial outer surfaces of two flippers 32a, 32b.

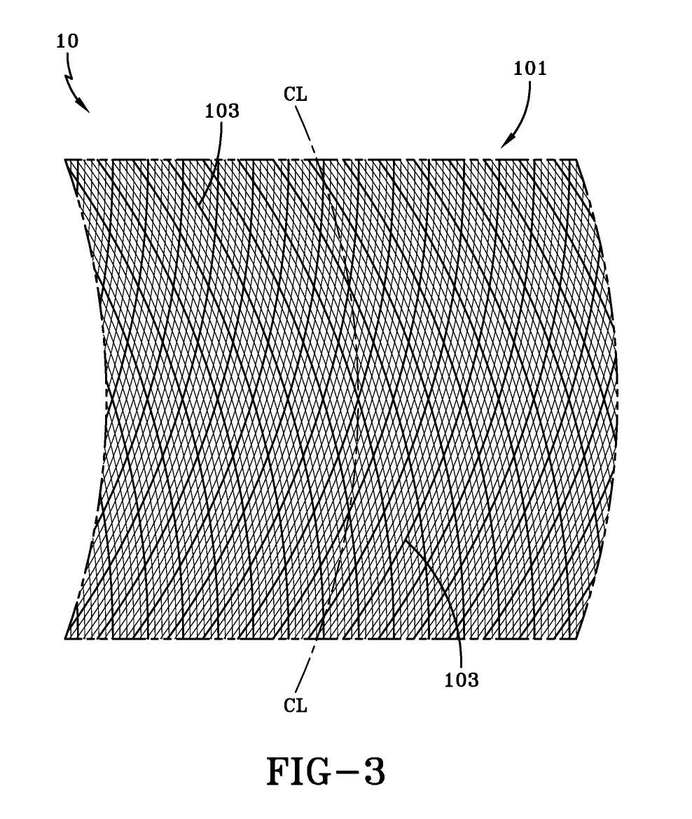

In accordance with the present invention, as shown in FIG. 3, the belts 18, 20 may be replaced with a single bidirectional belt 101 for reducing weight without degrading performance of the tire 10. Two-dimensional structural characteristics may be achieved with such a single reinforcement in which rubberized yarns/cords 103 are oriented in several directions (e.g., two directions of the two belt 18, 20 construction). A further advantage to this structure is that forces are counteracted internally to the singe belt 101 rather than forces being counteracted between several layers (e.g., the belts 18, 20). Steel cords may also be replaced with lighter fiber cords 103 in this construction without degrading other functional properties of the tire 10. Such a single belt 101 may be wound in a continuous fashion using high performance fibers. In the two bidirectional example of FIG. 3, the cords 103 may be interlaced or radially separate. Both provide a reduced weight to the conventional two belt 18, 20 approach.

As stated above, a single belt 101 in accordance with the present invention may produce reduced weight with comparable performance in a tire 10. This single belt 101 thus lightens the tire 10 with essentially no performance tradeoff, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry. Mayni.

A pneumatic tire has certain essential structural elements. United States Department of Transportation, Mechanics of Pneumatic Tires, pages 207-208 (1981). An important structural element is the belt, typically made up of many flexible, high modulus cords of natural textile, synthetic polymer, glass fiber, or fine hard drawn steel embedded in, and bonded to, a matrix of low modulus polymeric material, usually natural or synthetic rubber. Id. at 207 through 208.

The flexible, high modulus cords are usually disposed as two belts. Id. at 208. Tire manufacturers throughout the industry cannot agree or predict the effect of different twists of cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | | CARCASS | | | | | |
|---|---|---|---|---|---|---|---|
| | LINER | PLY | BEAD/APEX | BELT | OV'LY | TREAD | MOLD |
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE | X | X | X | | | X | |
| COMFORT | | | | | | | |
| HIGH SPEED | | X | X | X | X | X | X |
| AIR | X | | | | | | |
| RETENTION | | | | | | | |
| MASS/ | X | X | X | X | X | X | X |
| WEIGHT | | | | | | | |

As seen in the table, belt characteristics affect the other components of a pneumatic tire (i.e., belt affects carcass ply, overlay, bead/apex, etc.), leading to a number of components interrelating and interacting in such a way as to affect a group of functional properties (noise, handling, durability, comfort, high speed, and mass/weight), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when a belt structure of a pneumatic tire 10 is modified with the intent to improve one functional property of the pneumatic tire, any number of other functional properties may be unacceptably degraded. Furthermore, the interaction between the belt (e.g., bidirectional cords, etc.) and the carcass ply, overlay, tread, bead/apex may also unacceptably affect the functional properties of the pneumatic tire. A modification of the carcass ply may not even improve that one functional property because of these complex interrelationships.

Thus, as stated above, the complexity of the interrelationships of the multiple components makes the actual result of modification of a carcass ply, in accordance with the present invention, impossible to predict or foresee from the infinite possible results. Only through extensive experimentation has the single belt 101 of the present invention been revealed as an excellent, unexpected, and unpredictable option for a complete belt structure.

The previous descriptive language is the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed:

1. A pneumatic tire comprising:
a carcass reinforced by a carcass ply extending from a first bead to a second bead; and
a single belt ply disposed radially outward of the carcass ply in a crown portion of the pneumatic tire,
the single belt ply comprising a first group of cords oriented in a first direction relative to a centerline of the pneumatic tire and a second group of cords oriented in a second direction relative to the centerline of the pneumatic tire.

2. The pneumatic tire of claim 1 wherein the first group of cords has a linear density value in the range between 1000 dtex to 4000 dtex.

3. The pneumatic tire of claim 2 wherein the first group of cords has a structure of one single polyamide/nylon core yarn and only two aramid wrap yarns.

4. The pneumatic tire of claim 3 wherein the first group of cords has an end count of cord ends per inch in the range between 15-32.

5. The pneumatic tire of claim 4 wherein the second group of cords has a linear density value in the range between 1000 dtex to 2000 dtex.

6. The pneumatic tire of claim 4 wherein the second group of cords has a linear density value in the range between 3000 dtex to 4000 dtex.

7. The pneumatic tire of claim 6 wherein the second group of cords has a structure of one single polyamide/nylon core yarn and only two aramid wrap yarns.

8. The pneumatic tire of claim 7 wherein the second group of cords has an end count of cord ends per inch in the range between 15-32.

9. A method for designing a pneumatic tire comprising:
replacing a first belt and a second belt with a single third belt, the third belt comprising a first group of cords oriented in a first direction relative to a centerline of the pneumatic tire and a second group of cords oriented in a second direction relative to the centerline of the pneumatic tire.
